(19) United States
(12) Patent Application Publication
(10) Pub. No.: US 2024/0278950 A1
(43) Pub. Date: Aug. 22, 2024

(54) TRANSVERSE SEALING UNIT FOR PRODUCING TRANSVERSE SEALING SEAMS IN A TUBULAR BAG MACHINE

(71) Applicant: ROVEMA GMBH, Fernwald (DE)

(72) Inventor: Alexander Geiss, Feldatal (DE)

(21) Appl. No.: 18/570,385

(22) PCT Filed: May 18, 2022
(86) PCT No.: PCT/EP2022/063396

§ 371 Date: Dec. 14, 2023

(30) Foreign Application Priority Data
Jun. 15, 2021 (DE) 10 2021 115 459.6

(51) Int. Cl. B65B 51/26; B65B 9/20

(52) U.S. Cl. CPC B65B 51/26; B65B 9/20

(57) ABSTRACT

The invention relates to a transverse-sealing unit (09) for producing transverse-sealing seams in a tubular-bag machine (01), the transverse-sealing unit (09) comprising at least one sealing bar (11) which comes into sealing contact with at least one effective area when transversely sealing the film tube (05), and the transverse-sealing unit (09) comprising a support element (12) in which the sealing bar (11) is fastened, and the sealing bar having at least two effective-area sections (13, 14, 15), and the first effective-area section (15) protruding slightly over the second effective-area section (13, 14). The sealing bar (11) is mounted so as to be displaceable on the support element (12) in the direction of its longitudinal axis.

The invention relates to a transverse-sealing unit for producing transverse-sealing seams in a tubular-bag machine according to the preamble of claim 1.

A tubular-bag machine is known from DE 10 2010 028 697 A1, for example. The tubular-bag machine can be a vertically working or horizontally working tubular-bag machine, meaning the tubular bags are conveyed either vertically or horizontally through the tubular-bag machine. The tubular-bag machine can be driven either continuously or intermittently for this purpose.

To produce the transverse-sealing seams on the tubular bags, transverse-sealing units comprising a sealing bar and a support element are used in known tubular-bag machines. For this purpose, the sealing bar is typically detachably fastened to the support element and can come into sealing contact against the film tube with an effective area when transverse sealing. The sealing bar is suitably fastened to the support element in order to transfer the mechanical forces and the required actuation of the transverse-sealing drive to the sealing bar in this manner.

Depending on the corresponding tubular-bag format to be produced, it is necessary for some application cases for the sealing film to be folded inwards in the area of the transverse-sealing seams or to be reformed in a different manner. Consequently, the sealing film is not just double-layered in the area of the transverse-sealing seams, like in regular tubular bags. If the tubular bag is laterally folded inwards for producing a block bag, for example, the sealing film is quadruple-layered in the area of the inward fold, where the transverse-sealing seam is sealed. In order to compensate the differing thickness of the sealing material along the transverse-sealing seams and thus ensure a mostly uniform sealing pressure when producing the transverse-sealing seams, it has been known to equip the sealing bar with several effective-area sections, at least one effective-area section protruding over the other effective-area sections. This protrusion allows compensating the differing thickness of the sealing material between the transverse-seal jaws.

When using sustainable film materials, only a fairly thin coat of sealable material is present on the film web in many cases. In order to still be able to reliably transversely seal these film materials having a thin coat thickness of sealing material, it is required to precisely hit the different effective-area sections of the sealing bar at the corresponding sealing areas along the sealing seam. For in particular the transition from the double-layered sealing area to the quadruple-layered sealing area poses an error source due to the relatively small amount of sealing material with regard to the correct sealing of the transverse-sealing seam. With the known transverse-sealing units, the film web must therefore be oriented precisely in relation to the transverse-sealing jaws in the scope of the machine installation, which is cost- and labor-intensive.

Starting from this state of the art, it is therefore the object of the invention at hand to propose a transverse-sealing unit for producing transverse-sealing seams in a tubular-bag machine, the transverse-sealing unit overcoming the disadvantages of the known prior art.

Advantageous embodiments of the invention are the subject matter of the dependent claims.

The transverse-sealing unit according to the invention is based on the fundamental idea that the sealing bar is mounted so as to be displaceable on the support element in the direction of its longitudinal axis. In this manner, the sealing bar can be displaced transversely to the conveyance direction of the film web within the tubular-bag machine in relation to the support element. If it is determined upon installing a tubular-bag machine with a new film web that the effective-area sections present on the sealing bar do not abut precisely against the desired areas of the transverse-sealing seam and to this extent pressure is not optimally distributed along the entire transverse-sealing seam, the sealing bar can be displaced in relation to the support element and thus the sealing result can be optimized.

The number of effective-area sections the sealing bar has is generally arbitrary. It is particularly preferred if the sealing bar has three effective-area sections, the middle effective-area section protruding slightly over the right and left effective-area section. The middle effective-area section can then seal the part of the transverse-sealing seam where the film webs of the film tube are double. The right and left effective-area section can then come into sealing contact against the area of the film tube having a quadruple-layered film web.

In order to particularly easily and precisely displace the sealing bar in relation to the support element, it is particularly advantageous if the transverse-sealing unit comprises an adjustment unit by means of which the sealing bar is adjustable in the direction of its longitudinal axis in relation to the support element.

The adjustment unit can be designed in a particularly simple and cost-efficient manner in the manner of an adjustment screw. By turning the adjustment screw, which engages in a corresponding thread in the sealing bar, the sealing bar can be displaced in relation to the support element. The transverse-sealing unit according to the invention offers particularly great advantages when it is a component of a format set which can be assigned to a specific film web. When exchanging the film web for producing a different type of tubular bags, the sealing bar can also be exchanged without difficulty and be adjusted in relation to the support element in order to realize an optimal sealing result at the transverse-sealing seam of the new film web.

Of particularly great importance is the use of the transverse-sealing units for film webs whose paper content is high, as these film webs have only a fairly thin coat thickness of sealing material and therefore allow an only narrow margin of optimized sealing parameters. With regard to the sustainability of the use of film material, it is particularly advantageous when the paper content in the film web is at least 95%.

An embodiment of the invention is schematically shown in the drawings and is exemplarily described in the following.

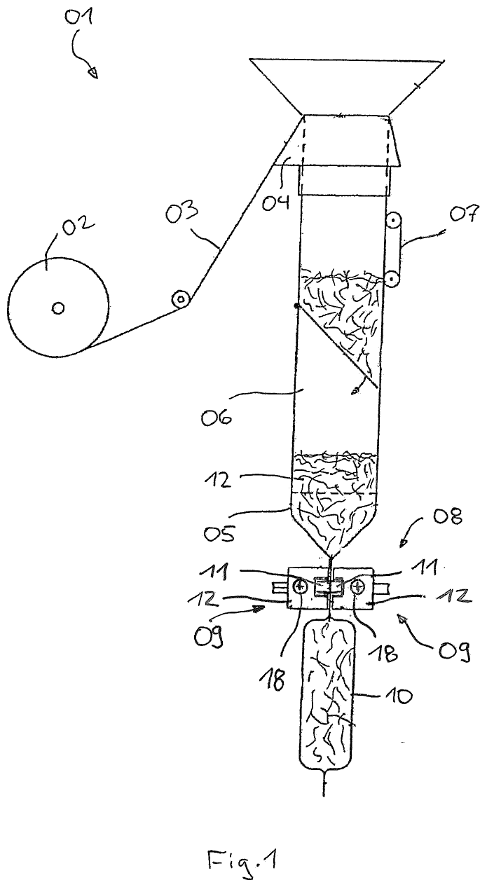

FIG. 1 shows a schematically illustrated tubular-bag machine having two adjustable transverse-sealing units;

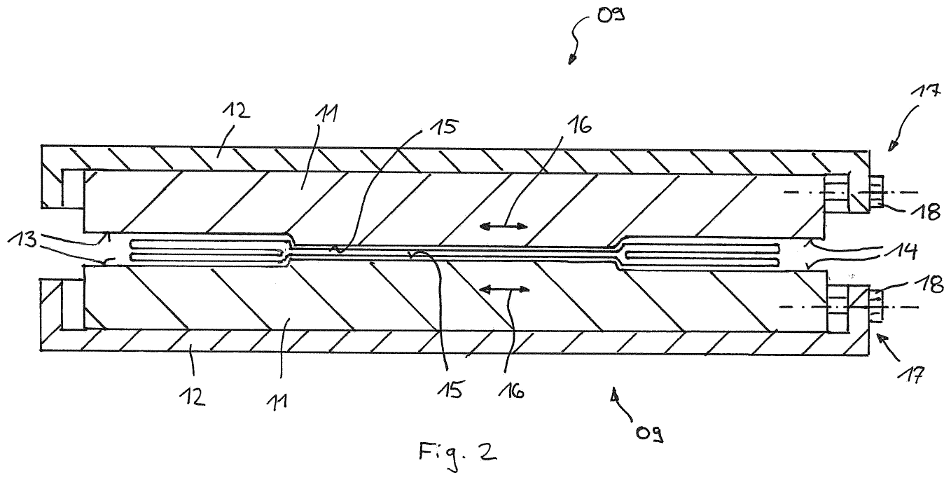

FIG. 2 shows the two transverse-sealing units of the tubular-bag machine according to FIG. 1 in a schematic longitudinal cut.

FIG. 1 shows a schematically illustrated tubular-bag machine 01, though only the parts of tubular-bag machine 01 are illustrated in FIG. 1 which are required for the comprehension of the invention. A film web 03 is unwound from a supply roll 02 and subsequently formed to a film tube 05 at a forming shoulder 04. Film web 03 is a paper web coated with a sealing coat, the paper content being higher than 95%.

Film tube 05 slides downward on the exterior of a forming tube 06 driven by a film take-off unit 07, film tube 05 being longitudinally sealed parallel to a transport direction by means of longitudinal-sealing apparatus (not shown in FIG. 1). The conveyance speed of film web 03 is monitored using corresponding sensor technology.

Below forming tube 06 is located a transverse-sealing apparatus 08 having two transverse-sealing units 09 for generating transverse-sealing seams via which film tube 05 is transversally sealed to form individual tubular bags 10. The drive of transverse-sealing units 09 and the separator for separating individual tubular bags 10 are not shown in FIG. 1.

Both transverse-sealing units 09 comprise a sealing bar 11 and a support element 12 each and are described in more detail in the following using FIG. 2.

FIG. 2 shows both transverse-sealing units 09 in a longitudinal cut extending along a transverse-sealing seam to be formed. Film web 03 of film tube 05 can be seen, which has been folded laterally so as to form a block bottom. In the area folded inwards, film web 03 of film tube 05 is quadruple-layered, whereas only two layers of the film web lie on top of each other in the middle area.

In order to evenly distribute the pressure along the transverse-sealing seam despite the differing layer thickness when sealing film tube 05, both sealing bars 11 have three effective-area sections 13, 14, 15 each. In this context, the middle effective-area section protrudes over right and left effective-area section 13 and 14 and comes into sealing contact against double-layered film tube 05 with its effective area. Right and left effective-area section 13 and 14 have a greater space in the end position of pressed-together transverse-sealing units 09 and each come into contact at the quadruple-layered film web of film tube 05. Owing to the protrusion of middle effective-area section 15 with respect to both outer effective-area sections 13 and 14, a uniform pressure distribution of the sealing pressure is ensured when transverse sealing.

Both sealing bars 11 are mounted in both support elements 12 so as to be displaceable along actuation direction 16 transversely to the conveyance direction of film tube 05, i.e., in the direction of its longitudinal axis. The position of both sealing bars 11 in relation to respectively assigned support elements 12 can be adjusted by displacing an adjustment apparatus 17 by turning an adjustment screw 18. When adjusting a tubular-bag machine for producing tubular bags with a different film material, sealing bars 11 can be easily adjusted in relation to support elements 12. In doing so, the position of effective-area sections 13, 14 and 15 is optimized in relation to the position of the double-layered and/or quadruple-layered film-tube areas by adjusting adjustment screw 18.

1. A transverse-sealing unit (09) for producing transverse-sealing seams in a tubular-bag machine (01), the transverse-sealing unit (09) comprising at least one sealing bar (11) which comes into sealing contact with at least one effective area when transversely sealing the film tube (05), and the transverse-sealing unit (09) comprising a support element (12) in which the sealing bar (11) is fastened, and the sealing bar having at least two effective-area sections (13, 14, 15), and the first effective-area section (15) protruding slightly over the second effective-area section (13, 14), wherein the sealing bar (11) is mounted so as to be displaceable on the support element (12) in the direction of its longitudinal axis.

2. The transverse-sealing unit according to claim 1, wherein the sealing bar (11) has three effective-area sections (13, 14, 15), the middle effective-area section (15) protruding slightly over the right and left effective-area section (13, 14).

3. The transverse-sealing unit according to claim 2, wherein the middle effective-area section (15) comes into sealing contact against an area of the film tube (05) having a double-layered film web (03).

4. The transverse-sealing unit according to claim 2, wherein the right and left effective-area section comes into sealing contact against an area of the film tube having a quadruple-layered film web.

5. The transverse-sealing unit according to claim 1, wherein the transverse-sealing unit comprises an adjustment unit by means of which the position of the sealing bar is adjustable in the direction of its longitudinal axis in relation to the support element.

6. The transverse-sealing unit according to claim 5, wherein the adjustment unit comprises at least one adjustable screw.

7. The transverse-sealing unit according to claim 1, wherein the transverse-sealing unit is a component of a format set which is assigned to a specific film web.

8. The transverse-sealing unit according to claim 7, wherein the format set is assigned to a film web having a high paper content.

9. The transverse-sealing unit according to claim 8, wherein the format set is assigned to a film web whose paper content is at least 95%.
